(19) United States
(12) Patent Application Publication
(10) Pub. No.: US 2020/0402783 A1
(43) Pub. Date: Dec. 24, 2020

(54) NOVEL PARTIAL-PRESSURE MASS SPECTROMETER CALIBRATION DEVICE AND METHOD

(71) Applicant: LANZHOU INSTITUTE OF PHYSICS, Lanzhou (Gansu Province) (CN)

(72) Inventors: Detian LI, Lanzhou (CN); Wenjun SUN, Lanzhou (CN); Yongjun CHENG, Lanzhou (CN); Zhenhua XI, Lanzhou (CN); Zhengnan YUAN, Lanzhou (CN); Lan ZHAO, Lanzhou (CN); Meng DONG, Lanzhou (CN); Meiru GUO, Lanzhou (CN)

(21) Appl. No.: 16/888,262

(22) Filed: May 29, 2020

Related U.S. Application Data
(63) Continuation of application No. PCT/CN2017/000749, filed on Dec. 25, 2017.

(30) Foreign Application Priority Data
Nov. 29, 2017 (CN) 201711221169.X

(51) Int. Cl. H01J 49/00; G01L 27/00

(52) U.S. Cl. CPC H01J 49/0009; G01L 27/002

(57) ABSTRACT

The present invention provides a novel partial-pressure mass spectrometer calibration device, which is mainly composed of a fine adjustment valve, a piston pressure gauge, a sample preparation chamber, a plurality of high-purity gas cylinders, a capacitive film vacuum gauge, a first-stage sample inlet chamber, a second-stage sample inlet chamber, sampling chambers, a small hole, a calibration chamber, a separation gauge and air pumping systems, wherein the sample preparation chamber is connected with the piston pressure gauge and the capacitive film vacuum gauge; the sample preparation chamber is also connected with the plurality of high-purity gas cylinders which are connected in parallel via the fine adjustment valve; a plurality of sampling chambers with different volumes are connected in parallel between the sample preparation chamber and the first-stage sample inlet chamber; a plurality of sampling chambers with different volumes are connected in parallel between the first-stage sample inlet chamber and the second-stage sample inlet chamber; the second-stage sample inlet chamber is sequentially connected with the small hole and the calibration chamber in series; the calibration chamber is connected with a to-be-calibrated partial-pressure mass spectrometer and the separation gauge; and the sample preparation chamber, the first-stage sample inlet chamber, the second-stage sample inlet chamber and the calibration chamber are connected with the air pumping systems. According to the present invention, an actually required mixed gas can be prepared according to customer requirements. In addition, it can be ensured that a gas does not change in the calibration process.

### CROSS REFERENCE TO RELATED APPLICATIONS

This application is a continuation of International Application No. PCT/CN2017/000749 filed Dec. 25, 2017, which claims the benefit of priority to Chinese Application No. 201711221169.X filed Nov. 29, 2017. The disclosure of these prior-filed applications is incorporated by reference herein in its entirety.

### TECHNICAL FIELD

The present invention relates to a novel partial-pressure mass spectrometer calibration device and method, and belongs to the technical field of vacuum measurement.

### BACKGROUND

Partial-pressure mass spectrometers are widely used in various fields of industrial production, and calibration of partial-pressure mass spectrometers is an important research direction in the field of vacuum measurement. Document “Robert E. Ellefson. Methods for in situ QMS calibration for partial pressure and composition analysis. Vacuum, 2014” describes a partial-pressure mass spectrometer calibration device, which combines two calibration methods: (1) a mixed gas with known components is directly introduced into a calibration chamber through a thin tube, and the partial-pressure value of each component is obtained through a series of theoretical calculations by using an ionization vacuum gauge as a reference standard; (2) a high-pressure mixed gas of about 100 kPa is first introduced into a sample inlet chamber, then the mixed gas is introduced into the calibration chamber through a thin tube, and the partial-pressure value of each component is obtained through theoretical calculation by using a capacitive film vacuum gauge with a full range of 1 kPa connected to the sample inlet chamber as a reference standard. This partial-pressure calibration device can calibrate a partial-pressure mass spectrometer by using the mixed gas.

The disadvantages of this system are as follows: (1) only the prepared mixed gas with known components can be used for calibration, and the gas cannot be prepared according to actual needs; (2) the gas state before sample inlet (before the gas enters the thin tube) is a viscous flow state, and the gas state after the sample inlet is changed into a molecular flow state, so that the composition of the mixed gas are changed after the sample inlet, and a calibration result needs to be corrected through complex theoretical calculation; and (3) the reference standards adopted are an ionization vacuum gauge and a capacitive film vacuum gauge, respectively, resulting in a large measurement uncertainty of the calibration result.

### SUMMARY

In view of this, the technical problem solved by the present invention is: to overcome the disadvantages of existing calibration devices and methods, and to provide a novel partial-pressure mass spectrometer calibration device and method, which can not only prepare an actually required mixed gas according to customer requirements, but also can attenuate the gas pressure to a molecular flow range before the gas enters a small hole, thus ensuring that the gas does not change in the calibration process.

The technical solution of the present invention is as follows.

A novel partial-pressure mass spectrometer calibration device is mainly composed of a fine adjustment valve, a piston pressure gauge, a sample preparation chamber, a plurality of high-purity gas cylinders, a capacitive film vacuum gauge, a first-stage sample inlet chamber, a second-stage sample inlet chamber, sampling chambers, a small hole, a calibration chamber, a separation gauge and an air pumping system, wherein:

the sample preparation chamber is connected with the piston pressure gauge and the capacitive film vacuum gauge, and the sample preparation chamber is also connected with the plurality of high-purity gas cylinders which are connected in parallel via the fine adjustment valve; a plurality of sampling chambers with different volumes are connected in parallel between the sample preparation chamber and the first-stage sample inlet chamber; a plurality of sampling chambers with different volumes are connected in parallel between the first-stage sample inlet chamber and the second-stage sample inlet chamber; the second-stage sample inlet chamber is sequentially connected with the small hole and the calibration chamber in series; the calibration chamber is connected with a to-be-calibrated partial-pressure mass spectrometer and the separation gauge; and the sample preparation chamber, the first-stage sample inlet chamber, the second-stage sample inlet chamber and the calibration chamber are connected with the air pumping system.

Preferably, the air pumping system according to the present invention includes a first pumping system, a second pumping system and a third pumping system.

Preferably, the fine adjustment valve according to the present invention is an ultra-high vacuum all-metal fine adjustment valve.

Preferably, the measurement accuracy of the piston pressure gauge according to the present invention is 0.0015% of a reading.

Preferably, valves are arranged on pipelines connected between adjacent components according to the present invention, and the valves are all ultra-high vacuum all-metal angle valves.

Preferably, the sample preparation chamber according to the present invention is of a spherical structure made of SUS316L stainless steel and has a volume of 10 L.

Preferably, the measurement range of the capacitive film vacuum gauge according to the present invention is 10⁻² Pa to 10⁵ Pa, and the measurement accuracy is 0.08% of a reading.

Preferably, the three sampling chambers are connected in parallel between the sample preparation chamber and the first-stage sample inlet chamber according to the present invention.

Preferably, three sampling chambers are connected in parallel between the first-stage sample inlet chamber and the second-stage sample inlet chamber according to the present invention.

Preferably, the three sampling chambers connected in parallel between the sample preparation chamber and the first-stage sample inlet chamber according to the present invention are of spherical structures made of SUS316L stainless steel and have volumes of 1 L, 0.1 L and 0.01 L, respectively.

Preferably, the three sampling chambers connected in parallel between the first-stage sample inlet chamber and the second-stage sample inlet chamber according to the present invention are of spherical structures made of SUS316L stainless steel and have volumes of 1 L, 0.1 L and 0.01 L, respectively.

Preferably, the first-stage sample inlet chamber and the second-stage sample inlet chamber according to the present invention are of horizontal structures made of SUS316L stainless steel and have volumes of 100 L.

Preferably, the attenuation ratio of the small hole according to the present invention is 1/100000.

Preferably, the calibration chamber according to the present invention is of a double-ball chamber structure made of SUS316L stainless steel, and has an ultimate vacuum degree of less than 10⁻⁹ Pa.

Preferably, the gas contained in each of the plurality of high-purity gas cylinders according to the present invention is a single-component high-purity gas.

Preferably, the measurement lower limit of the separation gauge according to the present invention is 10⁻¹⁰ Pa.

A novel partial-pressure mass spectrometer calibration method includes the following specific process:

Step 1, vacuumizing the partial-pressure mass spectrometer calibration device by the first, second and third air pumping systems, and measuring the vacuum degree of the calibration chamber by the separation gauge to ensure that the vacuum degree of the calibration chamber is within a required range;

Step 2, shutting down the first and second air pumping systems and enabling the third air pumping system to continue to vacuumize the calibration chamber, opening the fine adjustment valve, sequentially introducing required gases in the high-purity gas cylinders into the sample preparation chamber according to the proportion of a single-component gas in a mixed gas, and measuring pressures p₀₁, p₀₂ . . . of various introduced gases by the capacitive film vacuum gauge;

Step 3, measuring a total pressure p₀ of the sample preparation chamber by the piston pressure gauge;

Step 4, selecting and opening a gas inlet path from the sample preparation chamber to the second-stage sample inlet chamber according to the calibration range of the to-be-calibrated partial-pressure mass spectrometer to expand the mixed gas in the sample preparation chamber into the second-stage sample inlet chamber;

Step 5, introducing the gas into the calibration chamber through the small hole after the pressure in the second-stage sample inlet chamber is stable;

Step 6, connecting a pipeline connecting the calibration chamber and the partial-pressure mass spectrometer, reading an ion current of each gas by the partial-pressure mass spectrometer, and obtaining a sensitivity of the partial-pressure mass spectrometer to each gas according to the ion current and pressure of each gas, the total pressure p₀ and the pressure of the second-stage sample inlet chamber, thereby realizing calibration of the partial-pressure mass spectrometer.

Further, the process of sequentially introducing the gases in the plurality of high-purity gas cylinders into the sample preparation chamber according to the present invention is as follows: introducing a first gas into the sample preparation chamber, and measuring the gas pressure poi by the capacitive film vacuum gauge; vacuumizing a gas inlet pipeline by the first air pumping system, repeatedly flushing the gas inlet pipeline for a plurality of times by a second gas, then introducing the second gas into the sample preparation chamber, and measuring a gas pressure (p₀₁+p₀₂) at this time by the capacitive film vacuum gauge, wherein a difference of the two measurement results of the capacitive film vacuum gauge is the partial-pressure p₀₂ of the second gas; and obtaining the partial-pressures p₀₁, p₀₂ . . . of all prepared sample gases in a similar manner.

Beneficial Effects:

(1) According to the present invention, by controlling a plurality of high-purity gas cylinders which are connected in parallel, different gases can be prepared according to the required proportion to form a mixed gas, and the pressure of the mixed gas is measured by a capacitive film vacuum gauge with a measuring result irrelevant to gas components, so that calibration requirements of different customers can be met.

(2) According to the present invention, by using a high-precision piston pressure gauge as a backing standard, according to the calibration pressure range required by the to-be-calibrated partial-pressure mass spectrometer, when the gas is expanded into the second-stage sample inlet chamber from the sample preparation chamber, different gas inlet paths can be selected so that the pressure of the gas is attenuated to the molecular flow range before the gas passes through the small hole.

(3) According to the present invention, the gas in the molecular flow state is introduced into the calibration chamber through the small hole, so that the gas pressure is further attenuated to the required calibration pressure, and calibration of the partial-pressure mass spectrometer in the partial-pressure range of 10⁻⁹ Pa to 10⁻⁵ Pa can be achieved; the calibration pressure is only related to the backing standard pressure, the volume ratio before and after expansion, and the conductance ratio of the small hole; the proportion of components of gas is not changed during the calibration process, and the measurement uncertainty of calibration of the partial-pressure mass spectrometer is reduced.

### BRIEF DESCRIPTION OF THE DRAWING

FIG. 1 is a schematic diagram of the structural design principle of a novel partial-pressure mass spectrometer calibration device according to the present invention. In the figure, 1—fine adjustment valve, 2—piston pressure gauge, 3, 5, 7, 8, 11, 12, 14, 15, 18, 19, 20, 23, 25, 28, 30, 31, 32, 34, 35, 36, 38, 39, 40, 42, 43—valves, 4—sample preparation chamber, 6—capacitive film vacuum gauge, 9—first sampling chamber, 10—second sampling chamber, 13—first-stage sample inlet chamber, 16—fourth sampling chamber, 17—fifth sampling chamber, 21—second-stage sample inlet chamber, 22—small hole, 24—calibration chamber, 26, 27, 29—high-purity gas, 33—third sampling chamber, 37—sixth sampling chamber, 41—to-be-calibrated partial-pressure mass spectrometer, 44—separation gauge.

### DETAILED DESCRIPTION OF THE EMBODIMENTS

The present invention will be described in detail below in conjunction with the drawing and specific embodiments.

### Embodiment 1

A novel partial-pressure mass spectrometer calibration device is mainly composed of a fine adjustment valve 1, a piston pressure gauge 2, a sample preparation chamber 4, a plurality of high-purity gas cylinders, a capacitive film vacuum gauge 6, a first-stage sample inlet chamber 13, a second-stage sample inlet chamber 21, sampling chambers, a small hole 22, a calibration chamber 24, a separation gauge 44 and air pumping systems, wherein:

the sample preparation chamber 4 is connected with the piston pressure gauge 2 and the capacitive film vacuum gauge 6, and the sample preparation chamber 4 is also connected with the plurality of high-purity gas cylinders which are connected in parallel via the fine adjustment valve 1; a plurality of sampling chambers with different volumes are connected in parallel between the sample preparation chamber 4 and the first-stage sample inlet chamber 13; a plurality of sampling chambers with different volumes are connected in parallel between the first-stage sample inlet chamber 13 and the second-stage sample inlet chamber 21; the second-stage sample inlet chamber 21 is sequentially connected with the small hole 22 and the calibration chamber 24 in series; the calibration chamber 24 is connected with a to-be-calibrated partial-pressure mass spectrometer 41 and the separation gauge 44; and the sample preparation chamber 4, the first-stage sample inlet chamber 13, the second-stage sample inlet chamber 21 and the calibration chamber 24 are connected with the air pumping systems.

According to the present invention, a plurality of sampling chambers with different volumes are connected in parallel between the sample preparation chamber 4 and the first-stage sample inlet chamber 13, and a plurality of sampling chambers with different volumes are connected in parallel between the first-stage sample inlet chamber 13 and the second-stage sample inlet chamber 21. Thus the gas can take a variety of paths from the sample preparation chamber to the first-stage sample inlet chamber and then to the second-stage sample inlet chamber. Different gas inlet paths can be selected according to the calibration pressure range required by the to-be-calibrated partial-pressure mass spectrometer, so that the pressure of the gas is attenuated to the molecular flow range before the gas passes through the small hole. Furthermore, by controlling a plurality of high-purity gas cylinders which are connected in parallel, different gases can be prepared according to the required proportion to form a mixed gas, so that calibration requirements of different customers can be met.

A novel partial-pressure mass spectrometer calibration method includes the following specific process:

Step 1, vacuumizing the partial-pressure mass spectrometer calibration device by the air pumping system, and measuring the vacuum degree of the calibration chamber 24 by the separation gauge 44 to ensure that the vacuum degree of the calibration chamber 24 is within a required range;

Step 2, shutting down the remaining pumping system and continuing to vacuumize the calibration chamber 24, opening the fine adjustment valve 1, sequentially introducing required gases in the high-purity gas cylinders into the sample preparation chamber 4 according to the proportion of a single-component gas in a mixed gas, and measuring pressures p₀₁, p₀₂ . . . of various introduced gases by the capacitive film vacuum gauge 6;

Step 3, measuring a total pressure p₀ of the sample preparation chamber by the piston pressure gauge 2;

Step 4, selecting and opening a gas inlet path from the sample preparation chamber 4 to the second-stage sample inlet chamber 21 according to the calibration range of the to-be-calibrated partial-pressure mass spectrometer 41 to expand the mixed gas in the sample preparation chamber 4 into the second-stage sample inlet chamber 21;

Step 5, introducing the gas into the calibration chamber 24 through the small hole 22 after the pressure in the second-stage sample inlet chamber 21 is stable; and

Step 6, connecting a pipeline connected between the calibration chamber 24 and the partial-pressure mass spectrometer 41, reading an ion current of each gas by the partial-pressure mass spectrometer 41, and obtaining a sensitivity of the partial-pressure mass spectrometer 41 to each gas according to the ion current and pressure of each gas, the total pressure p₀ and the pressure of the second-stage sample inlet chamber 21, thereby realizing calibration of the partial-pressure mass spectrometer 41.

### Embodiment 2

In this embodiment, three sampling chambers are connected in parallel between the sample preparation chamber 4 and the first-stage sample inlet chamber 13, and three sampling chambers are connected in parallel between the first-stage sample inlet chamber 13 and the second-stage sample inlet chamber 21. In particular:

A novel partial-pressure mass spectrometer calibration device is mainly composed of a fine adjustment valve 1, a piston pressure gauge 2, valves 3, 5, 7, 8, 11, 12, 14, 15, 18, 19, 20, 23, 25, 28, 30, 31, 32, 34, 35, 36, 38, 39, 40, 42 and 43, a sample preparation chamber 4, a capacitive film vacuum gauge 6, a first sampling chamber 9, a second sampling chamber 10, a first-stage sample inlet chamber 13, a fourth sampling chamber 16, a fifth sampling chamber 17, a second-stage sample inlet chamber 21, a small hole 22, a calibration chamber 24, n high-purity gas cylinders 26, 27, 29, a third sampling chamber 33, a sixth sampling chamber 37, a separation gauge 44, a first air pumping system, a second air pumping system and a third air pumping system, wherein,

after being respectively connected with the valves 25, 28 and 30, the n high-purity gas cylinders 26, 27 and 29 connected in parallel are connected with the sample preparation chamber 4 via the valve 31 and the fine adjustment valve 1; the piston pressure gauge 2 is connected with the sample preparation chamber 4 via the valve 3 to measure a backing standard pressure; the capacitive film vacuum gauge 6 is connected with the sample preparation chamber 4 via the valve 5 to measure the pressure of each gas in the gas preparation process; the first sampling chamber 9, the second sampling chamber 10 and the third sampling chamber 33 are connected with the sample preparation chamber 4 via the valves 7, 8 and 32 respectively, and are connected with the first-stage sample inlet chamber 13 via the valves 11, 12 and 34 respectively; the fourth sampling chamber 16, the fifth sampling chamber 17 and the sixth sampling chamber 37 are connected with the first-stage sample inlet chamber 13 via the valves 14, 15 and 36 respectively, and are connected with the second-stage sample inlet chamber 21 via the valves 18, 19 and 38 respectively; the small hole 22 is connected with the second-stage sample inlet chamber 21 via the valve 20, and is connected with the calibration chamber 24 via the valve 23; the to-be-calibrated partial-pressure mass spectrometer 41 is connected with the calibration chamber 24 via the valve 40; the separation gauge 44 is connected with the calibration chamber 24 via the valve 43 to measure the base pressure of the calibration chamber; and the first air pumping system is connected with the sample preparation chamber, the second air pumping system is connected with the first-stage sample inlet chamber and the second-stage sample inlet chamber, and the third air pumping system is connected with the calibration chamber.

According to the present invention, three sampling chambers with different volumes are connected in parallel between the sample preparation chamber 4 and the first-stage sample inlet chamber 13, and three sampling chambers with different volumes are connected in parallel between the first-stage sample inlet chamber 13 and the second-stage sample inlet chamber 21. Thus the gas can take 9 paths from the sample preparation chamber to the first-stage sample inlet chamber and then to the second-stage sample inlet chamber. Different gas inlet paths can be selected according to the calibration pressure range required by the to-be-calibrated partial-pressure mass spectrometer, so that the pressure of the gas is attenuated to the molecular flow range.

In this embodiment, the valves are preferably ultra-high vacuum all-metal angle valves; the fine adjustment valve 1 is an ultra-high vacuum all-metal fine adjustment valve; and the attenuation ratio of the small hole 22 is 1/100000.

The specific calibration process is as follows:

(1) starting the first air pumping system, the second air pumping system and the third air pumping system to pump out air in the sample preparation chamber 4, the first sampling chamber 9, the second sampling chamber 10, the first-stage sample inlet chamber 13, the fourth sampling chamber 16, the fifth sampling chamber 17, the second-stage sample inlet chamber 21, the calibration chamber 24, the third sampling chamber 33, the sixth sampling chamber 37 and the vacuum pipeline;

(2) shutting down the first air pumping system and the second air pumping system, opening the fine adjustment valve 1, and introducing high-purity gases 26, 27 and 29 into the sample preparation chamber 4 based on the proportion of a single-component gas in the mixed gas from small to large according to calibration requirements of a customer. The specific process is as follows: introducing a first gas into the sample preparation chamber 4, and measuring the gas pressure poi by the capacitive film vacuum gauge 6; vacuumizing a gas inlet pipeline by the first air pumping system, repeatedly flushing the gas inlet pipeline for three times by using a second gas, then introducing the second gas into the sample preparation chamber 4, and measuring a gas pressure (p₀₁+p₀₂) at this time by the capacitive film vacuum gauge 6, wherein a difference of the two measurement results of the capacitive film vacuum gauge 6 is the partial-pressure p₀₂ of the second gas; and obtaining the partial-pressures p₀₁, p₀₂ . . . of all prepared sample gases in a similar manner;

(3) measuring a total pressure of the sample preparation chamber by the piston pressure gauge 2 as a backing standard pressure p₀;

(4) selecting different gas inlet paths according to the calibration range of the to-be-calibrated partial-pressure mass spectrometer, measuring the container volume ratio during the gas inlet, and calculating the gas pressure p₁ of the second-stage sample inlet chamber 21 after the gas inlet. The calculation method of one process is as follows: opening the valve 7 to introduce gas into the first sampling chamber 9, and closing the valve 7 after the pressure is stable, wherein the gas pressure in the first sampling chamber 9 is

$$\frac{{V}_{sample preparation}}{{V}_{sample preparation} + {V}_{first sampling}} {P}_{0} ;$$

then opening the valve 11 to expand the gas into the first-stage sample inlet chamber 13, and closing the valve 11 after the pressure is stable, wherein the gas pressure in the first-stage sample inlet chamber 13 is

$$\frac{{V}_{sample preparation} {V}_{first sampling}}{\begin{matrix}( {V}_{sample preparation} + {V}_{first sampling} ) \\ ( {V}_{first - stage sample inlet} + {V}_{first sampling} )\end{matrix}} {P}_{0} ;$$

then opening the valve 14 to introduce the gas into the fourth sampling chamber 16, and closing the valve 14 after the pressure is stable, wherein the gas pressure in the fourth sampling chamber 16 is

$$\frac{{V}_{sample preparation} {V}_{first sampling} {V}_{first - stage sample inlet}}{\begin{matrix}( {V}_{sample preparation} + {V}_{first sampling} ) \\ \begin{matrix}( {V}_{first - stage sample inlet} + {V}_{first sampling} ) \\ ( {V}_{first - stage sample inlet} + {V}_{fourth sampling} )\end{matrix}\end{matrix}} {P}_{0} ;$$

then opening the valve 18 to expand the gas into the second-stage sample inlet chamber 21, and closing the valve 18 after the pressure is stable, wherein the gas pressure Pi in the second-stage sample inlet chamber 21 is

$$\frac{{V}_{sample preparation} {V}_{first sampling} {V}_{first - stage sample inlet} {V}_{fourth sampling}}{\begin{matrix}( {V}_{sample preparation} + {V}_{first sampling} ) \\ \begin{matrix}( {V}_{first - stage sample inlet} + {V}_{first sampling} ) \\ \begin{matrix}( {V}_{first - stage sample inlet} + {V}_{fourth sampling} ) \\ ( {V}_{second - stage sample inlet} + {V}_{fourth sampling} )\end{matrix}\end{matrix}\end{matrix}} {P}_{0} ;$$

and referring to this calculation method for other gas inlet processes;

(5) opening the valves 20 and 23 to introduce the gas into the calibration chamber 24 through the small hole 22, wherein the total pressure in the calibration chamber 24 is

$$\frac{{P}_{1}}{100000} ,$$

and the standard partial-pressure of each sample gas is

$$\frac{{P}_{1}}{100000} \frac{{P}_{01}}{{P}_{0}} , \frac{{P}_{1}}{1 \; 00000} \frac{{P}_{02}}{{P}_{0}} , … \frac{{P}_{1}}{1 \; 00000} \frac{{P}_{0 i}}{{P}_{0}} ;$$

and

(6) opening the valve 40, reading the ion current I₁, I₂ . . . Iᵢ of each sample gas by the partial-pressure mass spectrometer 41, and obtaining the sensitivity of the partial-pressure mass spectrometer to a certain gas being

$$\frac{100000}{{P}_{1}} \frac{{I}_{1} {P}_{0}}{{P}_{01}} , \frac{1 \; 00000}{{P}_{1}} \frac{{I}_{2} {P}_{0}}{{P}_{02}} , … \frac{100000}{{P}_{1}} \frac{{I}_{i} {P}_{0}}{{P}_{0 i}} .$$

### Embodiment 3

In this embodiment, the gas to be prepared is a prepared mixed gas of He and Ar, and the volume ratio is 1:4.

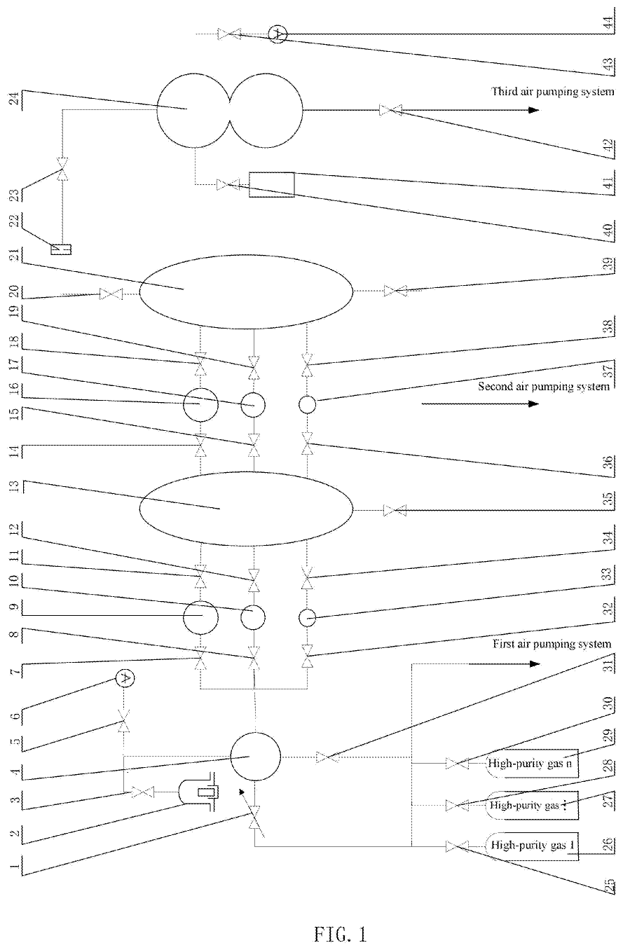

As shown in FIG. 1, a novel partial-pressure mass spectrometer calibration device designed in the present invention is composed of a fine adjustment valve 1, a piston pressure gauge 2, valves 3, 5, 7, 8, 11, 12, 14, 15, 18, 19, 20, 23, 25, 28, 30, 31, 32, 34, 35, 36, 38, 39, 40, 42 and 43, a sample preparation chamber 4, a capacitive film vacuum gauge 6, a first sampling chamber 9, a second sampling chamber 10, a first-stage sample inlet chamber 13, a fourth sampling chamber 16, a fifth sampling chamber 17, a second-stage sample inlet chamber 21, a small hole 22, a calibration chamber 24, high-purity gases 26, 27 and 29, a third sampling chamber 33, a sixth sampling chamber 37, a to-be-calibrated partial-pressure mass spectrometer 41, a separation gauge 44, etc.

In this embodiment, various components are preferably designed or selected as follows: the measurement accuracy of the piston pressure gauge 2 is 0.0015% of a reading; the sample preparation chamber 4 is of a spherical structure made of SUS316L stainless steel and has a volume of 10 L; the measurement range of the capacitive film vacuum gauge 6 is 10⁻² Pa to 10⁵ Pa, and the measurement accuracy is 0.08% of a reading; three sampling chambers connected in parallel between the sample preparation chamber 4 and the first-stage sample inlet chamber 13, and three sampling chambers connected in parallel between the first-stage sample inlet chamber 13 and the second-stage sample inlet chamber 21 are of spherical structures made of SUS316L stainless steel and have volumes of 1 L, 0.1 L and 0.01 L, respectively; the first-stage sample inlet chamber 13 and the second-stage sample inlet chamber 21 are of horizontal structures made of SUS316L stainless steel and have volumes of 100 L; the attenuation ratio of the small hole 22 is 1/100000; the calibration chamber 24 is of a double-ball chamber structure made of SUS316L stainless steel, and has an ultimate vacuum degree of less than 10⁻⁹ Pa; a gas contained in each of the plurality of high-purity gas cylinders is a single-component high-purity gas; and the measurement lower limit of the separation gauge 44 is 10⁻¹° Pa.

The implementation steps are as follows:

(1) starting the first air pumping system, the second air pumping system and the third air pumping system to pump out air in the sample preparation chamber 4, the first sampling chamber 9, the second sampling chamber 10, the first-stage sample inlet chamber 13, the fourth sampling chamber 16, the fifth sampling chamber 17, the second-stage sample inlet chamber 21, the calibration chamber 24, the third sampling chamber 33, the sixth sampling chamber 37 and the vacuum pipeline;

(2) shutting down the first air pumping system and the second air pumping system, opening the fine adjustment valve 1, preparing a mixed gas of He and Ar with the volume ratio of He to Ar being 1:4 according to calibration requirements of a customer, introducing high-purity He into the sample preparation chamber, and measuring the gas pressure poi being 2×10³ Pa by the capacitive film vacuum gauge 6; vacuumizing a gas inlet pipeline by the first air pumping system, repeatedly flushing the gas inlet pipeline for three times by using Ar, then introducing Ar into the sample preparation chamber, and measuring a gas pressure (p₀₁+p₀₂) being 1×10⁴ Pa at this time by the capacitive film vacuum gauge, wherein a difference of the two measurement results of the capacitive film vacuum gauge is the partial-pressure p₀₂ of Ar being 8×10³ Pa;

(3) measuring a total pressure of the sample preparation chamber by the piston pressure gauge 2 as a standard backing pressure p₀ being 1.02×10⁴ Pa.

(4) selecting the gas inlet path from the first sampling chamber to the first-stage expansion chamber to the fourth sampling chamber to the second-stage expansion chamber when the calibration magnitude of the to-be-calibrated partial-pressure mass spectrometer is 10⁻⁶ Pa, wherein the container volume ratio during the gas inlet is

$$\frac{{V}_{sample preparation} {V}_{first sampling} {V}_{first - stage sample inlet} {V}_{fourth sampling}}{\begin{matrix}( {V}_{sample preparation} + {V}_{first sampling} ) \\ \begin{matrix}( {V}_{first - stage sample inlet} + {V}_{first sampling} ) \\ \begin{matrix}( {V}_{first - stage sample inlet} + {V}_{fourth sampling} ) \\ ( {V}_{second - stage sample inlet} + {V}_{fourth sampling} )\end{matrix}\end{matrix}\end{matrix}} = \frac{1000}{11333311} ,$$

and the gas pressure p₁ of the second-stage sample inlet chamber 21 after the gas inlet is 0.9 Pa;

(5) opening the valves 20 and 23 to introduce the gas into the calibration chamber 24 through the small hole 22, wherein the total pressure in the calibration chamber 24 is 9×10⁻⁶ Pa, the standard partial-pressure of He is 1.8×10⁻⁶ Pa, and the standard partial-pressure of Ar is 7.2×10⁻⁶ Pa; and

(6) opening the valve 40, reading the ion currents of He and Ar being 8.1×10⁻¹⁴ A and 5.9×10⁻¹³ A respectively by the partial-pressure mass spectrometer 41, and obtaining the sensitivity of the partial-pressure mass spectrometer to He and Ar as 4.5×10⁻⁸ A/Pa and 8.2×10⁻⁸ A/Pa respectively.

In summary, the above embodiments are only preferred embodiments of the present invention and are not intended to limit the scope of protection of the present invention. Any modifications, equivalent alternatives, improvements, etc., which are within the spirit and principle of the present invention, should be included in the scope of protection of the present invention.

1. A partial-pressure mass spectrometer calibration device, comprising: a fine adjustment valve (1), a piston pressure gauge (2), a sample preparation chamber (4), a plurality of high-purity gas cylinders, a capacitive film vacuum gauge (6), a first-stage sample inlet chamber (13), a second-stage sample inlet chamber (21), sampling chambers, a small hole (22), a calibration chamber (24), a separation gauge (44) and air pumping systems, wherein:
the sample preparation chamber (4) is connected with the piston pressure gauge (2) and the capacitive film vacuum gauge (6), and the sample preparation chamber (4) is also connected with the plurality of high-purity gas cylinders which are connected in parallel via the fine adjustment valve (1); a plurality of sampling chambers with different volumes are connected in parallel between the sample preparation chamber (4) and the first-stage sample inlet chamber (13); a plurality of sampling chambers with different volumes are connected in parallel between the first-stage sample inlet chamber (13) and the second-stage sample inlet chamber (21); the second-stage sample inlet chamber (21) is sequentially connected with the small hole (22) and the calibration chamber (24) in series; the calibration chamber (24) is connected with a to-be-calibrated partial-pressure mass spectrometer (41) and the separation gauge (44); and the sample preparation chamber (4), the first-stage sample inlet chamber (13), the second-stage sample inlet chamber (21) and the calibration chamber (24) are connected with the air pumping systems.

2. The partial-pressure mass spectrometer calibration device according to claim 1, wherein the air pumping systems comprise a first air pumping system, a second air pumping system and a third air pumping system.

3. The partial-pressure mass spectrometer calibration device according to claim 1, wherein the fine adjustment valve (1) is an ultra-high vacuum all-metal fine adjustment valve.

4. The partial-pressure mass spectrometer calibration device according to claim 1, wherein the measurement accuracy of the piston pressure gauge (2) is 0.0015% of a reading.

5. The partial-pressure mass spectrometer calibration device according to claim 1, wherein valves are arranged on pipelines connected between the adjacent components, and the valves are all ultra-high vacuum all-metal angle valves.

6. The partial-pressure mass spectrometer calibration device according to claim 1, wherein the sample preparation chamber (4) is of a spherical structure made of SUS316L stainless steel and has a volume of 10 L.

7. The partial-pressure mass spectrometer calibration device according to claim 1, wherein the measurement range of the capacitive film vacuum gauge (6) is 10⁻² Pa to 10⁵ Pa, and the measurement accuracy is 0.08% of a reading.

8. The partial-pressure mass spectrometer calibration device according to claim 1, wherein three sampling chambers are connected in parallel between the sample preparation chamber (4) and the first-stage sample inlet chamber (13).

9. The partial-pressure mass spectrometer calibration device according to claim 1, wherein three sampling chambers are connected in parallel between the first-stage sample inlet chamber (13) and the second-stage sample inlet chamber (21).

10. The partial-pressure mass spectrometer calibration device according to claim 8, wherein the three sampling chambers connected in parallel between the sample preparation chamber (4) and the first-stage sample inlet chamber (13) are of spherical structures made of SUS316L stainless steel and have volumes of 1 L, 0.1 L and 0.01 L, respectively.

11. The partial-pressure mass spectrometer calibration device according to claim 9, wherein the three sampling chambers connected in parallel between the first-stage sample inlet chamber (13) and the second-stage sample inlet chamber (21) are of spherical structures made of SUS316L stainless steel and have volumes of 1 L, 0.1 L and 0.01 L, respectively.

12. The partial-pressure mass spectrometer calibration device according to claim 1, wherein the first-stage sample inlet chamber (13) and the second-stage sample inlet chamber (21) are of horizontal structures made of SUS316L stainless steel and have volumes of 100 L.

13. The partial-pressure mass spectrometer calibration device according to claim 1, wherein the attenuation ratio of the small hole (22) is 1/100000.

14. The partial-pressure mass spectrometer calibration device according to claim 1, wherein the calibration chamber (24) is of a double-ball chamber structure made of SUS316L stainless steel, and has an ultimate vacuum degree of less than 10⁻⁹ Pa.

15. The partial-pressure mass spectrometer calibration device according to claim 14, wherein the measurement lower limit of the separation gauge (44) is 10⁻¹⁰ Pa.

16. A partial-pressure mass spectrometer calibration method based on the partial-pressure mass spectrometer calibration device according to claim 2, comprising:
Step 1, vacuumizing the partial-pressure mass spectrometer calibration device by the first, second and third air pumping systems, and measuring the vacuum degree of the calibration chamber (24) by the separation gauge (44) to ensure that the vacuum degree of the calibration chamber (24) is within a required range;
Step 2, shutting down the first and second air pumping systems and enabling the third air pumping system to continue to vacuumize the calibration chamber (24), opening the fine adjustment valve (1), sequentially introducing required gases in the high-purity gas cylinders into the sample preparation chamber (4) according to the proportion of a single-component gas in a mixed gas, and measuring pressures p₀₁, p₀₂ . . . of various introduced gases by the capacitive film vacuum gauge (6);
Step 3, measuring a total pressure p₀ of the sample preparation chamber (4) by the piston pressure gauge (2);
Step 4, selecting and opening a gas inlet path from the sample preparation chamber (4) to the second-stage sample inlet chamber (21) according to the calibration range of the to-be-calibrated partial-pressure mass spectrometer (41) to expand the mixed gas in the sample preparation chamber (4) into the second-stage sample inlet chamber (21);
Step 5, introducing the gas into the calibration chamber (24) through the small hole (22) after the pressure in the second-stage sample inlet chamber (21) is stable; and
Step 6, connecting a pipeline connected between the calibration chamber (24) and the partial-pressure mass spectrometer (41), reading an ion current of each gas by the partial-pressure mass spectrometer (41), and obtaining a sensitivity of the partial-pressure mass spectrometer (41) to each gas according to the ion current and pressure of each gas, the total pressure p₀ and the pressure of the second-stage sample inlet chamber (21) for realizing calibration of the partial-pressure mass spectrometer (41).

17. The partial-pressure mass spectrometer calibration method according to claim 16, wherein the process of sequentially introducing the gases in the plurality of high-purity gas cylinders into the sample preparation chamber (4) comprises: introducing a first gas into the sample preparation chamber (4), and measuring the gas pressure p₀₁ by the capacitive film vacuum gauge (6); vacuumizing a gas inlet pipeline by the first air pumping system, repeatedly flushing the gas inlet pipeline for a plurality of times by a second gas, then introducing the second gas into the sample preparation chamber (4), and measuring a gas pressure (p₀₁+p₀₂) at this time by the capacitive film vacuum gauge (6), wherein a difference of the two measurement results of the capacitive film vacuum gauge (6) is the partial-pressure p₀₂ of the second gas; and obtaining the partial-pressures p₀₁, p₀₂ . . . of all prepared sample gases by analogy.
